(19) United States
(12) Patent Application Publication
(10) Pub. No.: US 2025/0050904 A1
(43) Pub. Date: Feb. 13, 2025

(54) QUANTIFYING COMPLEXITY INFORMATION FOR AUTOMATED DRIVING SYSTEMS ON DISPARATE ROADWAYS AND ENHANCED USER INTERFACE GENERATION

(71) Applicant: AECOM, Los Angeles, CA (US)

(72) Inventors: Paul A. Avery, Round Rock, TX (US); Corby Schaub, Liberty Hill, TX (US); Suzanne Murtha, Punta Gorda, FL (US)

(21) Appl. No.: 18/469,209

(22) Filed: Sep. 18, 2023

Related U.S. Application Data
(60) Provisional application No. 63/519,028, filed on Aug. 11, 2023.

(51) Int. Cl. B60W 60/00; B60W 30/18; B60W 50/14

(52) U.S. Cl. CPC B60W 60/001; B60W 30/18159; B60W 30/18163; B60W 50/14; B60W 2552/00; B60W 2554/406; B60W 2555/20; B60W 2555/60

(57) ABSTRACT

Systems and methods for analyzing complexity information for automated driving on disparate roadways. An example method includes obtaining information defining a roadway on which an automated vehicle is to navigate, the information reflecting characteristics of portions of the roadway including geographical and/or behavior information; determining primary behaviors associated with roadway segments which form the roadway, wherein the roadway is segmented into the roadway segments based on adjustments of primary behavior which the automated vehicle will perform; determining complexity values for each roadway segment, wherein individual complexity values are based on the associated primary behavior and one or more complexity modifiers; and causing presentation of a user interface, wherein the user interface includes a roadway complexity value determined based on the complexity values.

### CROSS-REFERENCE TO RELATED APPLICATIONS

This application claims priority to U.S. Prov. Patent App. No. 63/519,028 titled “QUANTIFYING COMPLEXITY INFORMATION FOR AUTOMATED DRIVING SYSTEMS ON DISPARATE ROADWAYS AND ENHANCED USER INTERFACE GENERATION” and filed on Aug. 11, 2023, the disclosure of which is hereby incorporated herein by reference in its entirety.

### BACKGROUND

### Technical Field

The present disclosure relates to analyzing road information, and more particularly, to analyzing road information for automated driving.

### Description of Related Art

Automated vehicles are increasingly accessible to the public and have the potential to enhance safety of passengers and pedestrians. However, the successful deployment of these vehicles depends, in part, on their ability to navigate existing roadway environments populated with human roadway users safely and efficiently. Operational challenges for automated vehicles are related to interacting with other roadway users, such as human-driven vehicles, bicyclists, and pedestrians, as the behavior of humans can be unpredictable, and AVs generally lack the depth of context humans use to navigate the environment.

When navigating to a destination, an automated vehicle may follow navigation guidance that is not optimized for automated driving. Indeed, automated vehicles may use navigation applications that human drivers also use. Thus, such navigation guidance is not specific, and tailored, to automated vehicles.

### BRIEF DESCRIPTION OF THE DRAWINGS

FIG. 1A is a block diagram of an example complexity analysis system outputting a user interface that includes roadway complexity information.

FIG. 1B is a detailed block diagram of the complexity analysis system determining roadway complexity information.

FIG. 2 is a flowchart of an example process for determining roadway complexity information based on an input roadway.

FIG. 3A illustrates depictions of a roadway being segmented into roadway segments. In the illustrated example, roads associated with a geographic region are depicted.

FIG. 3B illustrates a depiction of roadway complexity information for the roadway segments.

FIG. 4A is a block diagram of the complexity analysis system in communication with an automated vehicle.

FIG. 4B is a block diagram of the complexity analysis system in communication with a multitude of automated vehicles and intelligent transportation system (ITS) devices.

FIG. 5 is an example user interface that includes roadway complexity information for a roadway.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

### Introduction

This specification describes techniques to determine the complexities of different roadways on which automated or semi-automated vehicles (collectively automated vehicles) may navigate. As may be appreciated, automated vehicles vary in their ability to safely perform common driving scenarios. For example, driving scenarios in which an automated vehicle is to navigate forward in defined lanes may be easier than some scenarios. In this example, an automated vehicle may be able to follow a lane on a highway or navigate from the lane to an offramp, and so on. However, other scenarios may require automated vehicles to anticipate actions of humans (e.g., drivers of vehicles, pedestrians, bicyclists, and so on) or other temporary roadway conditions (e.g., traffic, construction, lane closures, weather-related conditions, and so on). For example, an automated vehicle may be required to cross opposing traffic to make a left turn. As another example, an automate vehicle may have to determine when to accelerate from a stop sign. When traveling to a destination, an automated vehicle may encounter combinations of these driving scenarios.

As will be described, the disclosed technology allows for an understanding of the complexities of routes which may be taken to the destination. In this way, an automated vehicle may prefer a route with a lower complexity. The techniques described herein may also enable roadway designers to optimize roadways such that automated vehicle deployments are able to be accomplished sooner. Additionally, the techniques described herein may allow for designers to adjust current roadways to reduce complexities which may be encountered by automated vehicles.

A roadway, as described herein, may represent a route navigable by a vehicle from an initial location to a destination. An example roadway may include a public transportation route (e.g., a bus route). For this example, the roadway may be analyzed to determine a complexity associated with the route. In this example, roadway designers may use the techniques described herein to adjust the route to expedite the transition to automated public transportation (e.g., automated buses). Another example roadway may include a route for a personal automated vehicle, automated taxi, and so on. For this example roadway, the automated vehicle or taxi may prefer a route with a lower complexity as compared with other routes.

The roadways described above may be segmented into roadway segments. Advantageously, the segmentation may be based on driving scenarios which will be encountered by an automated vehicle. Thus, a behavior may be determined for each roadway segment. An example behavior may include the roadway segment being associated with straight travel along a roadway lane. Another example behavior may include the roadway segment having an intersection optionally associated with a particular maneuver type (e.g., protected left-turn, unprotected left-turn, complex lane connectivity, and so on). Another example behavior may include merge behavior. Each roadway segment may therefore be a discretized representation of a particular primary behavior.

The roadway segments which form a roadway may therefore be of variable length. As an example, a roadway which largely extends along a straight road, without intersections or other incursions into the road, may have a lengthy roadway segment reflecting the primary behavior of straight travel. Additional roadway segments may be substantially shorter and reflect primary behaviors of intersections, merges, and so on. These additional roadway segments may lead to, or from, the lengthy roadway segment. In contrast, segmentation based on length of geographical event (e.g., turns, changing from one freeway to another) may mask the actual complexity of a roadway. For example, multiple contiguous roadway segments may reflect the primary behavior of straight travel. In this example, roadway segments reflecting complex behaviors may be reduced in importance due to the overall greater number of roadway segments.

As will be described, the behavior assigned to a roadway segment may be associated with a complexity value. For example, the complexity value may be selected from a range between a first value and a second value (e.g., between 0 and 10, 0 and 20, 1 and 100, and so on). Higher complexities may therefore be assigned to more complex roadway segment behavior. Optionally, the complexity values may be modified based on additional information, such as may be supplied in real-time via intelligent transportation system (ITS) devices or other traffic monitoring systems. For example, roadway information (e.g., real-time traffic or weather information) may be used to adjust a complexity value upwards or downwards. In this example, an unprotected left-turn may have a higher complexity value during peak traffic.

The complexity values for a roadway may be used to determine a roadway complexity score reflecting the overall complexity. In some embodiments, the complexity values may be input into a formula (e.g., a linear or non-linear formula) to determine the roadway complexity score. In some embodiments, the complexity values may be input into a machine learning model (e.g., a neural network) which is trained to output the roadway complexity score. For example, a neural network may assign the score based on a non-linear activation function (e.g., a sigmoid).

The roadway complexity score for a roadway may be adjusted based on a specific automated vehicle being used. For example, and as may be appreciated, automated vehicles may have different sensor suites (e.g., cameras, emissive sensors) and execute different machine learning models. Thus, a first automated vehicle may be more mature with respect to a particular behavior than a second automated vehicle. In some embodiments, these distinctions and maturities may be incorporated into the complexity determination described herein. In this way, complexities may be tailored to specific automated vehicles and used to compare automated vehicle platforms.

This application therefore addresses current technological problems and improves upon prior analysis techniques. As automated driving increases in prominence, techniques to analyze roadways for complexity will become paramount. At present, automated vehicles do not account for complexity of a roadway and instead rely upon machine learning models to address any situation which might appear. The techniques described herein may, instead, allow for a holistic view of the complexity of a roadway and inform design changes for the roadway. Additionally, new roadways may be designed to reduce such complexities. Furthermore, and as will be described, the techniques described herein may allow for an automated vehicle to effectuate a real-time selection of a route from amongst a multitude of potential routes. For example, the selected route may be associated with a lower roadway complexity score.

### Example Block Diagrams

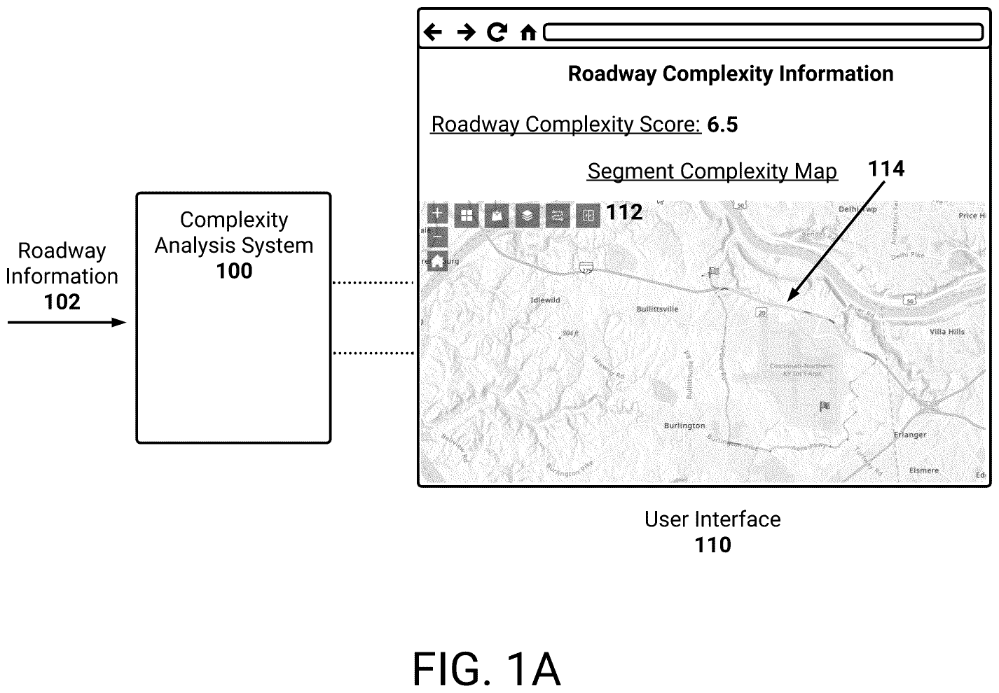

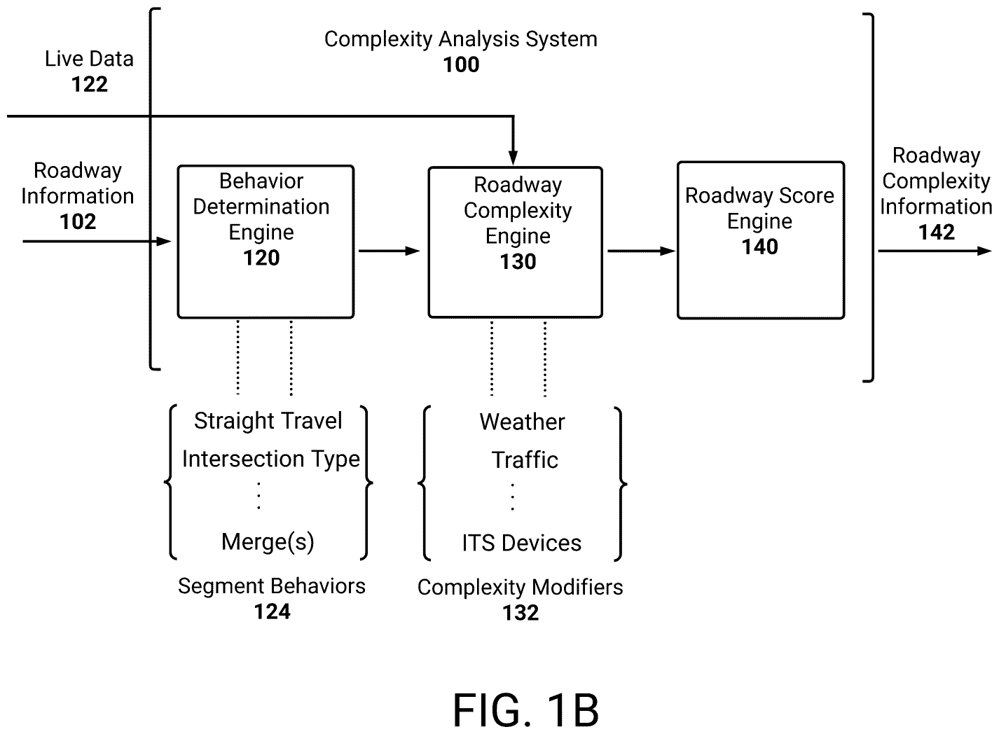

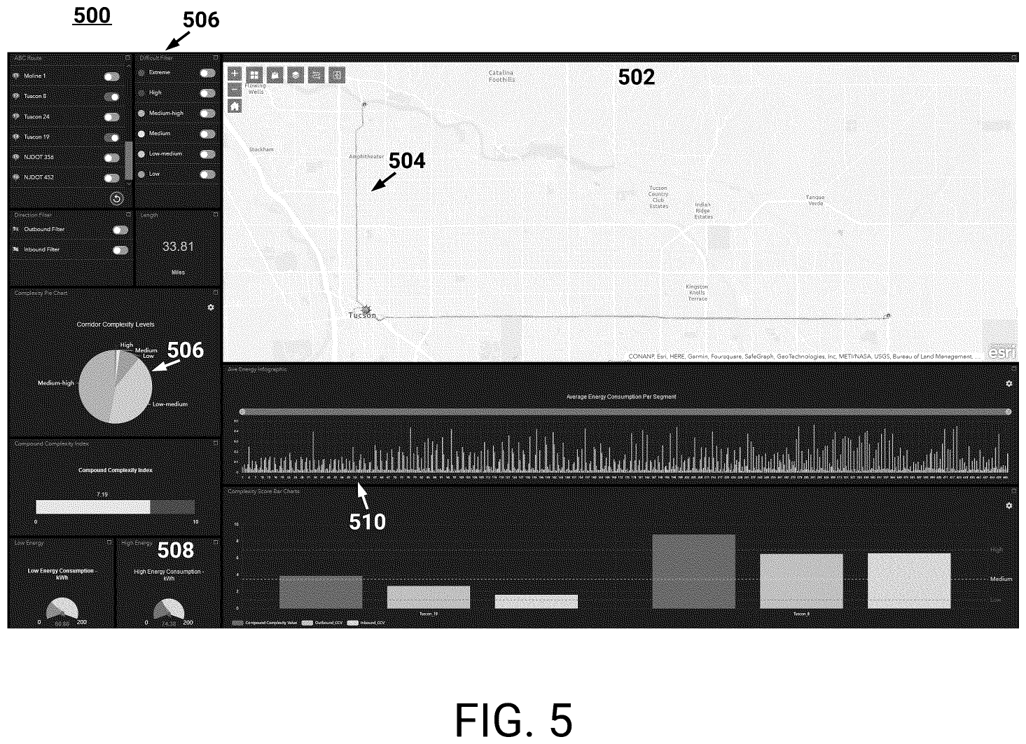

FIG. 1A is a block diagram of an example complexity analysis system 100 outputting a user interface 110 that includes roadway complexity information. As described herein, information 102 describing a roadway may be analyzed to determine a roadway complexity score reflecting the overall complexity of the roadway. User interface 110 may therefore include the determined information. An example user interface is included in FIG. 5.

The complexity analysis system 100 may represent a system of one or more processors, such as a user device executing an application or software. Example user devices may include a computer, laptop, tablet, smart phone, wearable device, and so on. The application or software may thus render user interface 110 for presentation via a display of a user device. In some embodiments, the complexity analysis system 100 may represent a back-end server or cloud system which determines information for inclusion in user interface 110. Thus, in some embodiments, user interface 110 may represent a front-end which is rendered, at least in part, by system 100 and presented via a user device.

In the illustrated example, roadway information 102 is being received by the complexity analysis system 100. The roadway information 102 may reflect a route from an initial location to a destination. In some embodiments, the information 102 may include geographic information system (GIS) information. For example, the information 102 may include geographic information which describes the roadway. In this example, the information 102 may identify street connectivity, lane connectivity, information indicating locations of traffic signs (e.g., stop signs), signal lights, and so on. The information 102 may additionally reflect turn radii of streets, numbers of lanes along a freeway or highway, interchanges between freeways or highways, and so on. The GIS information may be stored in a database, such as a spatial or geographic database.

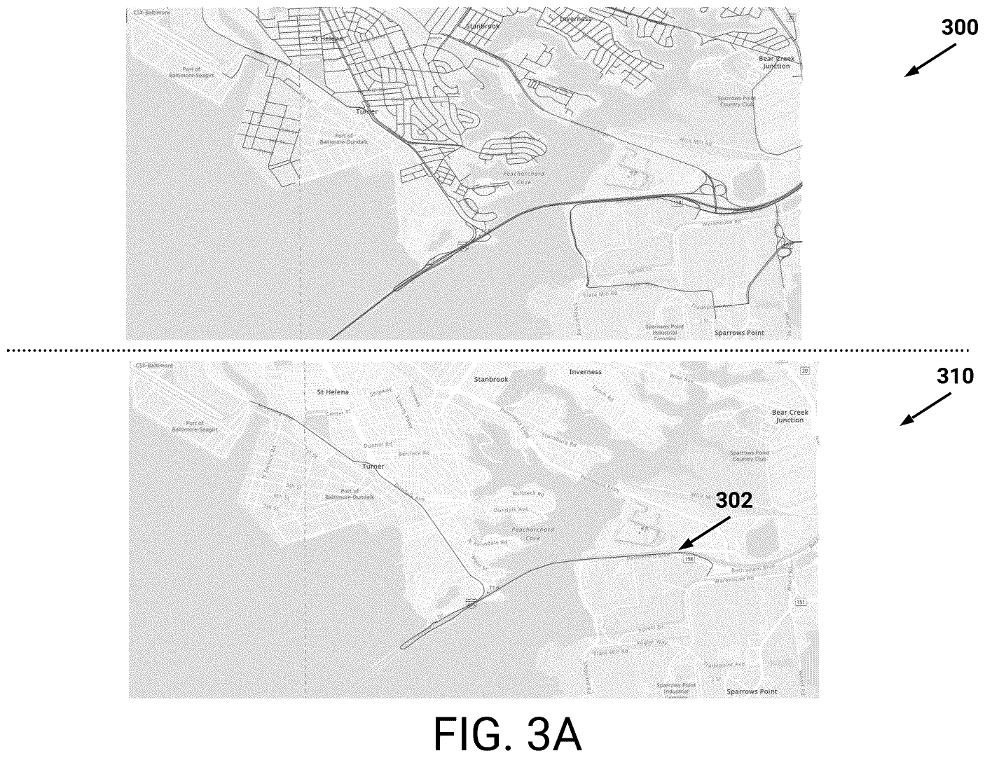

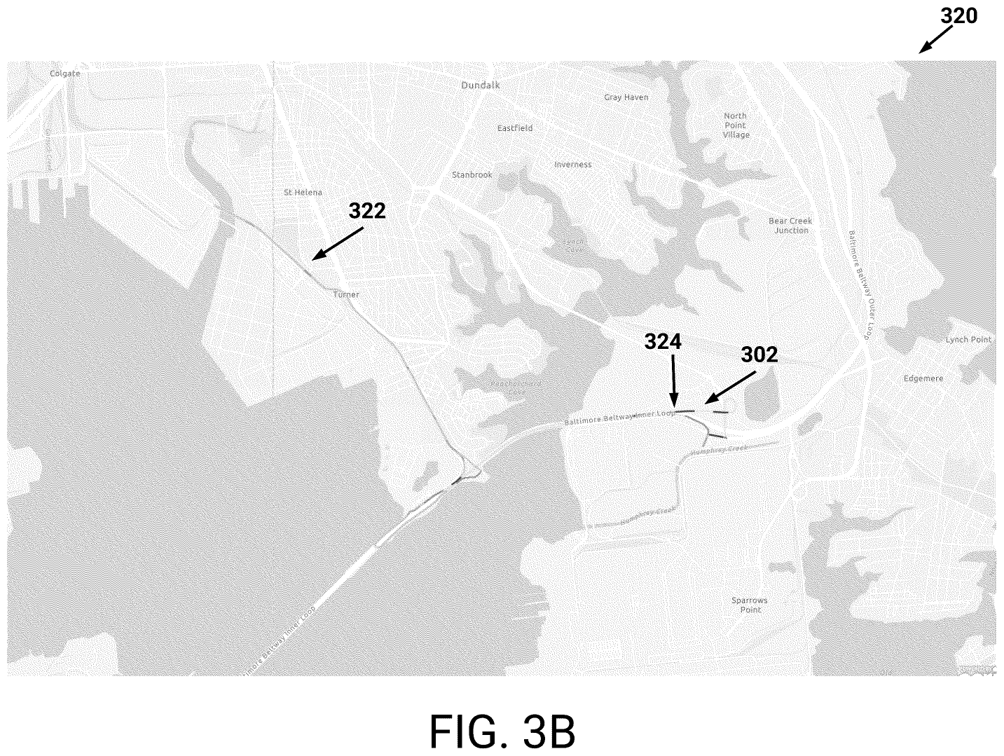

Thus, the roadway information 102 may be analyzed to identify a route which is being analyzed to determine a roadway complexity score. Specifically, a roadway may be identified as a route which is navigable from the initial location to the destination. An example of a roadway is illustrated in FIG. 3A and described below.

The complexity analysis system 100 may segment the roadway into a multitude of roadway segments. As described above, the system 100 may analyze the roadway to identify primary behaviors of discrete portions of the roadway. The system 100 may thus segment the roadway into roadway segments with each roadway segment representing an adjustment of behavior from a prior roadway segment. In some embodiments, the system 100 may simulate driving from the initial location to the destination. In some embodiments, the system 100 may identify primary behaviors based on analyzing the GIS information.

As an example, the system 100 may determine driving behaviors which an automated vehicle would need to perform when driving along the route. For this example, the system 100 may determine that a first portion of the roadway includes effectuating an unprotected left turn. The system 100 may also determine that a second portion of the roadway includes driving on hills with blind turns. The system 100 may also determine that a third portion of the roadway includes driving substantially straight in protected lanes. To determine this information, the system 100 may thus estimate the driving behaviors based on the GIS information. For example, and with respect to the first portion, the GIS information may indicate that an automated vehicle would be required to turn left, and that the GIS information reflects an unprotected left turn.

The system 100 may therefore segment the roadway into roadway segments based on assigning primary behaviors for the segments. These primary behaviors may be associated with complexity values. While primary behaviors are described herein, in some embodiments a segment may be assigned multiple behaviors. For example, a roadway segment may be associated with an intersection and a construction zone. In this example, the behavior may reflect complexity associated with traversing an intersection and traversing a construction zone.

This may be in contrast with traveling straight through a construction zone. Thus, the behavior of a roadway segment may be customized to accurately reflect reality. In some embodiments, the complexity values associated with multiple behaviors may be aggregated, or otherwise combined, to form a single complexity value for a roadway segment. For example, a measure of central tendency may be determined for the complexity values. As another example, respective weightings may be applied to each complexity value.

Based on these complexity values, the system 100 may determine a roadway complexity score. In FIG. 1A, the example roadway complexity score is ‘6.5’ which may represent a value selected between 1 and 10 or 0 and 10. The scoring range may help ensure standardized and easily interpretable complexity assessments among roadways with very different lengths and configurations. For example, certain automated vehicle tasks and environments may be trivial to safely execute, while some tasks may be very difficult or impossible to execute, and the transition between these two extremes may be rapid. As will be described, a non-linear function may be used to capture the slow accumulation of complex segments. For example, complex behaviors may trigger a rapid rise in the score, which may be followed by a saturation phase in which further behaviors do not increase the overall roadway complexity. An example technique to determine the roadway complexity score is described in more detail below with respect to FIG. 1B.

The user interface 110 may allow an end-user to quickly view the roadway complexity score for an input roadway. For example, the end-user may identify the initial location and destination and the system 100 may identify responsive roadways. In this example, the system 100 may select one of the roadways for analysis based on estimated travel time. The system 100 may also present the responsive roadways and the end-user may select from amongst them. In some embodiments, the end-user may provide user input to the user interface 110 to select roadway portions which form the roadway. For example, and with respect to a tablet, the end-user may drag her/his finger along the screen to identify the roadway portions which form the roadway. In some embodiments, the roadway may be previously defined. For example, the roadway may represent a public transportation route and the roadway may be selectable as corresponding to a particular route.

As illustrated, a map 112 depicting the roadway 114 may be included in the user interface 110. The roadway 114 may be assigned colors, patterns, or other graphical adjustments, based on the underlying complexity values. For example, a roadway segment may be assigned red reflecting a behavior with more complex interactions. As another example, a roadway segment may be assigned green or yellow reflecting behaviors with less complex interactions. In this way, the end-user may determine portions of the roadway 114 which are more, or less, complex.

In some embodiments, additional data such as real-time traffic or weather information may be used to determine complexity. The user interface 110 may optionally allow for simulation of complexity based on selection of traffic or weather. For example, the end-user may provide user input indicating heavy traffic and roadway segments may be adjusted in color to indicate increased complexity due to the increased interaction with other roadway users. In this example, certain portions may not be adjusted (e.g., straight driving portions) such that specific roadway segments may be clearly highlighted for complexity. Similarly, the end-user may indicate specific weather or types of weather. These types of weather may adjust complexity and cause updating of the user interface 110. For example, a steep hill may be associated with increased complexity based on rain or snow.

FIG. 1B is a detailed block diagram of the complexity analysis system 100 determining roadway complexity information 142. The information 142 may reflect, for example, complexity values associated with a roadway indicated in the roadway information 102. The complexity analysis system 100 may thus determine information which may be included in a user interface, such as described in FIG. 1A and FIG. 5.

The complexity analysis system 100 includes a behavior determination engine 120 which assigns behaviors 124 to roadway segments. As described in FIG. 1A, the system 100 may segment the roadway into roadway segments based on adjustment in driving behavior. Example behaviors may include, for example, straight travel, intersection type, merging, use of a dedicated automated vehicle lane, use of a carpool lane, and so on.

In some embodiments, the behavior determination engine 120 may simulate hypothetical driving behaviors or modifications in a roadway. For example, at present there may be no dedicated automated vehicle lanes. However, an end-user may indicate that a particular roadway segment is to have a dedicated automated vehicle lane. By inputting the relevant parameters and characteristics of these scenarios, the engine 120 can estimate their impact on the roadway complexity score. In this way, roadway designers may evaluate the potential benefits or challenges associated with future roadway changes.

The complexity analysis system 100 further includes a roadway complexity engine 130 which outputs complexity values for the roadway segments. As described above, each driving behavior may be associated with a complexity value. These complexity values may be modified by complexity modifiers 132. For example, roadway speeds, protected intersection movements, density of other roadway users, presence and/or density of parked vehicles on the road, presence of work or school zones, bike lanes adjacent to the lane of travel, and so on may be used to update the complexity value. As an example, a roadway segment which has heavy traffic or has an adjacent bike lane may be increased in complexity. A modifier 132 may additionally relate to a construction zone for a roadway segment. For example, if a construction zone is anticipated along a route, the engine 130 can incorporate a higher complexity level for that roadway segment. The engine 130 may analyze factors such as reduced lane width, temporary signage, and altered traffic patterns, all of which can cause additional difficulty for an automated vehicle to navigate the environment.

The roadway complexity engine 130 may additionally modify complexity values based on live data 122. The live data 122 may reflect current weather or traffic conditions for the roadway. The live data 122 may be obtained, for example, from intelligent transportation system (ITS) devices. Example devices may include sensors which detect vehicles, image sensors positioned proximate to the roadway, and so on. Traffic data, for example, can provide insights into congestion levels, average speeds, and traffic patterns along the route, including crashes. The engine 130 may increase complexity values based on the traffic data. For example, there may be tiers or levels of traffic. In this example, a tier or level of traffic may represent a range of traffic values (e.g., greater than a first threshold and less than a second threshold) according to a traffic metric (e.g., travel time, speed, count, delay, and so on). Each tier or level or traffic may be associated with a particular increase, or percentage increase, in the complexity values. Weather data, for example, can provide information about road conditions, visibility, and the presence of hazards like rain or snow. Similar to the above, different types of weather may be associated with different increases, or percentage increases, of complexity values. As an example, snow or dense fog may be associated with a greater increase than light rain.

In some embodiments, a complexity value for a particular roadway segment may be determined based on complexity values, or specific behaviors, of prior roadway segments. As an example, a first behavior may be associated with a higher complexity value based on a second behavior preceding it. An example first behavior may include driving onto a freeway onramp and an example second behavior may include crossing lanes of opposing traffic to turn left. For these example behaviors, it may be difficult to turn left across traffic, get into a lane, and then quickly cross lanes to the onramp.

The complex analysis system 100 further includes a roadway score engine 140 to determine a roadway complexity score for the roadway. Example techniques to determine the roadway complexity score are described below, however additional techniques may be employed and fall within the scope of the present disclosure. For example, a machine learning model may be trained to determine the score.

A first example technique may accumulate roadway segments as a summation of individual lengths of the individual roadway segments. A second example technique may accumulate roadway segments as a summation of segment ratios over the length of the roadway. These techniques may be determined based on the following:

$${Length}_{{D}_{{C}_{l}}} = {W}_{{C}_{l}} * \sum {S}_{{C}_{l}}$$

$${Ratio}_{{D}_{{C}_{l}}} {D}_{{C}_{l}} = {W}_{{C}_{l}} * \frac{\sum {S}_{{C}_{l}}}{T} ;$$

$${C}_{l} = \begin{matrix}Medium \\ Medium - high \\ High \\ Extreme\end{matrix}$$

where Cₗ represents the complexity level, and are the determinants of the roadway score,
S_{Cl} is the segment length for the specific complexity level,
W_{Cl} is the weighting factor for the specific complexity level, and
T represents the total length of the roadway under study.

In the example above, only roadway segments with at least a threshold complexity value are considered. For example, lower complexity values (e.g., driving straight) may not be included in some embodiments. In other examples, lower complexity values are included. Complexity values may be selected from different ranges, integers, float values, and so on. For example, a complexity.

With respect to the complexity level and general classification of Medium to Extreme, in some embodiments a same weighting factor may be used for complexity values which are within a particular complexity level range. Thus, a range of complexity values may correspond to a complexity of ‘Extreme’ in some embodiments.

For the example above, the engine 140 may determine the four determinants. The weighting factors used may represent scalar values which may be learned by the engine 140. In some embodiments, they may be about an order of magnitude apart. In some embodiments, the ‘Extreme’ weighting factor may be substantially higher than the other weighting factors. The weighting factors may optionally be pre-defined and not learned. In some embodiments, there may not be four general weighting factors but rather a continuous range based on complexity value. Thus, the function may in some embodiments be continuous.

A raw complexity score may be determined using segment lengths according to the determinants, and modified using the weighting factors and/or the total length of the route. The raw complexity sore may then be input into a non-linear equation to obtain the roadway complexity score. An example non-linear equation is included below:

$${C}_{s} = {V}_{max} * ( 1 - {e}^{( - k * r )} ) ; k > 0$$

where, V_{Max} is the upper bound of the complexity score,
r is the raw complexity score, and
k is a modification factor which determines the steepness in the transition from a low complexity score to a high complexity score.

Thus, the roadway score engine 140 may determine the roadway complexity score. As described in FIG. 1A, the score may be included in a user interface presented to the end-user. Additionally, colors may be assigned to roadway segments of the roadway based on their complexity values. As described above, the complexity values may, in some embodiments, be selected based on an assignment of whether a behavior is within a range of complexity (e.g., medium, medium to high, high, extreme, and so on).

### Example Flowchart

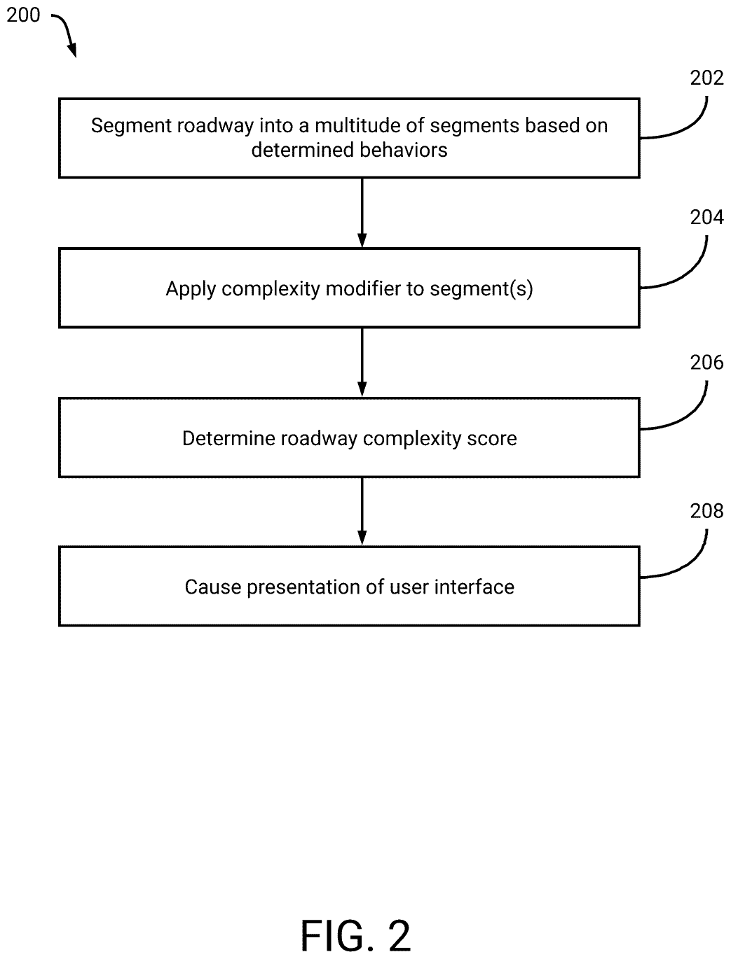

FIG. 2 is a flowchart of an example process 200 for determining roadway complexity information based on an input roadway. For convenience, the process 200 will be described as being performed by a system of one or more processors (e.g., the complexity analysis system 100).

At block 202, the system segments a roadway into a multitude of roadway segments. As described above, segmentation may be based on change or adjustment in driving behavior which will be encountered by an automated vehicle.

At block 204, the system applies complexity modifiers to the roadway segments. As described in FIGS. 1A-1B, the system assigns complexity values to the roadway segments based on their respective behaviors. The system may also adjust these complexity values based on modifiers. Example modifiers may relate to characteristics of traffic, the roadway segment (e.g., the segment may be unusually narrow), and so on. Additionally, the complexity values may be modified based on the capability maturity, and so on, of an automated vehicle which will be driving the roadway. For example, as automated vehicles increase in effectiveness the system may reduce complexity values for specific behaviors. The complexity values may also be modified based on a type of the automated vehicle (e.g., passenger vehicle, transit vehicle, box truck, large freight vehicle).

At block 206, the system determines the roadway complexity score. The system may use the complexity values to determine the overall roadway complexity score. For example, the system may compute the score based on the equations described in FIG. 1B.

At block 208, the system causes presentation of a user interface. The system may include information in the user interface for viewing by an end-user. The information may include, for example, the roadway complexity score, a graphical depiction of the roadway, and so on. In some embodiments, additional information may be included. For example, an automated vehicle may be electric. In this example, average energy used per roadway segment may be included (e.g., Watt-hours per mile).

The user interface may additionally include selectable options associated with different information. As an example, a selectable option may enable inclusion of live data (e.g., current weather, current traffic) in the determination of the complexity score. In some embodiments, live data may automatically be considered in the determination. As another example, a selectable option may cause presentation of summary information for complexity as it varies, or is expected to vary, during a year or arbitrary time period. For example, the system can determine complexity during a time period using different weather, traffic data, upcoming or anticipated construction events, increases in use based on public events (e.g., sports game), and so on. The user interface can then present a graph or chart illustrating the change in complexity score during the time period. A selectable option may additionally allow the end-user to select a particular date and view complexity information for that particular date.

In some embodiments, the user interface may indicate adjustments to the roadway which may cause the complexity score to be reduced. For example, the system may determine that certain behaviors may be adjusted, or changed to other behaviors, to better support use of automated vehicles. The system may additionally determine that sensors or devices that are installed on or near the roadway may reduce the complexity. For example, signal phase and timing (SPaT) information may cause a reduction in complexity. In this example, and as known by those skilled in the art, SPAT may indicate the upcoming traffic light and/or may indicate a time until the traffic light changes. An automated vehicle may use this information to inform braking, acceleration, and so on. As an example, a signal light may be positioned shortly after a sharp turn such that oncoming traffic has limited visibility to the signal light until being close. Thus, SPAT may allow an automated vehicle to ascertain the light status (e.g., green, red, yellow) prior to being within visible range.

Additional sensors or devices may include sensors to detect/track moving objects. For example, the sensors (e.g., lidar, radar, ultrasound, cameras) may be analyzed to determine one or more of location, speed, heading, and so on, of each object. Devices may additionally include devices which communicate their position relative to a fixed point. For example, a device may be positioned through a length of a tunnel and broadcast its distance from a tunnel entrance or exit.

The user interface may optionally include a drop-down menu or other user interface element to select sensors or devices to be included on or near the roadway. The system may then determine updated complexity information for the roadway. As may be appreciated, each sensor or device may be associated with a reduction of complexity (e.g., the sensor or device may modify complexity values to reduce the complexity score).

In some embodiments, the end-user may select a set of roadways for analysis. For example, the user interface may respond to user input selecting an option to indicate two or more roadways. The system may then determine complexity information for the set of roadways. The user interface may optionally include a ranking of the roadways according to different criteria. For example, the user interface may rank the roadways according to complexity. As another example, the user interface may rank the roadways according to a compound attribute (e.g., lowest complexity with most ridership, for example with respect to public transit).

In some embodiments, the end-user may indicate potential locations for transit or goods movement distribution hubs. For example, the end-user may view a map of a graphic location and provide user input to select a location, or set of locations, under consideration.

The system may then determine a route or subset of routes which have lowest complexity, or complexity scores less than a threshold, to/from a particular highway or other location. The system may additionally modify the complexity according to a particular automated vehicle to be used (e.g., an automated truck, semi-truck, and so on).

The system may analyze multimodal transportation designs. For example, a roadway may be analyzed for multiple vehicle types (e.g., passenger vehicle, transit, goods movement) to determine complexity for automated deployment feasibility. The system may present information in the user interface to indicate which roadways are suitable for a particular vehicle type (e.g., lowest complexity). The user interface may additionally identify, based on the complexity information, locations where specific challenges to deployment may exist. The location of transportation hubs (e.g., transit hubs, rail stations, vertiports) may optionally be selected as specific origin/destination locations of interest.

### Example Roadway

FIG. 3A illustrates depictions 300-310 of a roadway being segmented into roadway segments. In the illustrated example, roads associated with a geographic region are depicted. For example, depiction 300 includes the roads surrounding a particular route 302. In this example, an end-user or the complexity analysis system 100 may identify the route 302 as representing the roadway segment. The route 302 may represent, for example, a public transportation route being analyzed. The route 302 may also represent, for example, a route being traversed in real-time by an automated vehicle (e.g., an automated taxi).

While the description herein has focused on existing roadways, in some embodiments the system 100 may analyze a roadway under development. For example, computer aided design (CAD) information for a roadway may be obtained (e.g., from the end-user). The CAD information may reflect an underlying model associated with the road, such as information defining lengths, curves, intersections, positions, and so on, of the roadway and portions thereof. In this example, the end-user may additionally assign behaviors associated with portions of the roadway. In some embodiments, the CAD information may include information sufficient to determine the behaviors. For example, traffic signals, road signs, connections to existing roads, intersections, and so on, may be included.

The system 100 may then determine complexity information for the roadway under development. For example, the system may determine a complexity score as described above with respect to at least FIGS. 1A-2. Optionally, the end-user may indicate estimates of traffic or weather for the roadway. For example, the end-user may indicate that the roadway is expected to have traffic greater than a threshold metric. The end-user may also indicate traffic information as it varies during a weekday or weekend. The end-user may additionally identify a city, or specific location in the city, and the system 100 may determine estimates of traffic for the roadway. For example, the system 100 may identify that the roadway has an intersection with a road known to have traffic greater than a threshold. The system 100 may also simulate driver behavior and estimate whether the roadway will become a high throughput roadway (e.g., the roadway may represent a multiple laned road positioned proximate to single lane roads in a dense environment). The traffic information, as described above, may be used to inform the determination of complexity information. For example, the traffic information may be used to as an above-described modifier. Similarly, the system 100 may determine weather information based on a location in which the roadway is to be included. The weather information may be used, as described above, to determine complexity information for the roadway.

Optionally, the end-user may indicate an existing roadway which is expected to share similarities with the roadway under development (e.g., similar behaviors). The system 100 may then utilize, or otherwise import, complexity information associated with the existing roadway. For example, the existing roadway may be a highway which has several merges with other highways. In this example, the system 100 may analyze the complexity associated with these merges and use similar complexity values for these merges. The system 100 may additionally identify existing roadways which are expected to be similar to the roadway under development. For example, the system 100 may identify roadways with similar lengths, behaviors, and so on, and may present complexity information for these roadways in a user interface.

FIG. 3B illustrates a depiction 320 of roadway complexity information for the roadway segments. In the illustrated example, the route 302 has been assigned complexity information to roadway segments. A first portion 322 of the route 302 is assigned as having low complexity while a second part 324 is assigned as having increased complexity. In this way, a roadway designer may determine that adjustments are to be made to the second part 324. Additionally, an automated vehicle may select a different route which does not include the second part 324.

### Example Automated Vehicle Diagram

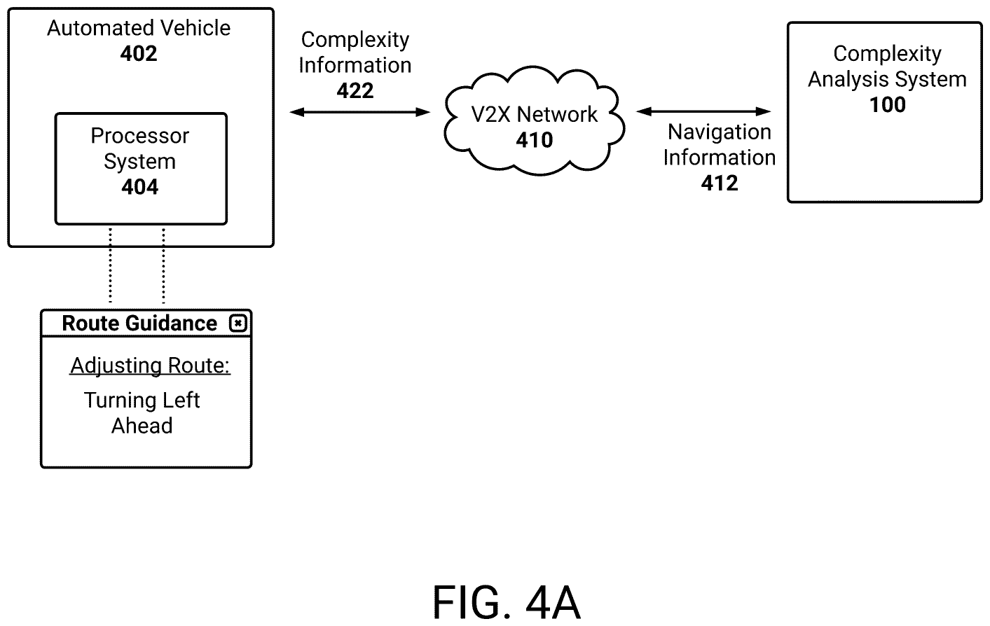

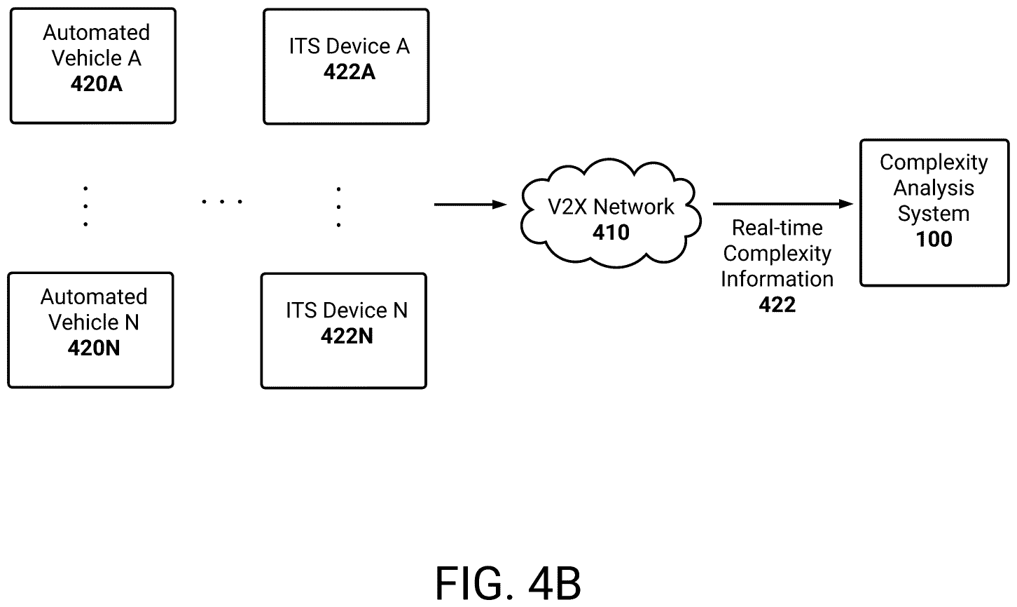

FIG. 4A is a block diagram of the complexity analysis system 100 in communication with an automated vehicle 402. As described above, in some embodiments the system 100 may provide complexity information 422 to the automated vehicle 402 for real-time usage. In the illustrated example, the automated vehicle 402 may communicate with the system 100 wirelessly. For example, a V2X network 410 may be used. As another example, a cellular network may be used.

In FIG. 4A, the automated vehicle 402 is providing navigation information 412 to the complexity analysis system 100. The automated vehicle 402 may provide a request for complexity information, optionally with the route it is going to travel, to the system 100. The information 412 may reflect the current route the automated vehicle is traversing. For example, the current route may reflect upcoming turns, a portion of an upcoming route (e.g., a route for a threshold distance), or the entire route. The information 412 may additionally reflect a multitude of potential routes the vehicle 402 could follow. The complexity analysis system 100 may analyze the route, or routes, as described herein. For example, the system 100 may segment the route, or routes, into roadway segments and determine complexity information (e.g., complexity values, roadway complexity scores). This complexity information 422 may then be provided to the automated vehicle 402.

The automated vehicle 402 may include a processor system 404 which is used for automated driving. Additionally, the system 404 may output information to a display included in the vehicle 402. In the illustrated example, the system 404 has determined to adjust its current route and will be turning left ahead. This may be based on complexity information, for example the automated vehicle 402 may prefer to avoid roadway segments with higher complexity. The vehicle 402 may also prefer to avoid certain roadway segments with moderate or high complexity given particular modifiers (e.g., weather conditions, traffic conditions, and so on as described herein).

While adjusting route may be informed by complexity information 422, the processor system 404 may additionally incorporate the information 422 into its automated driving platform. For example, the information 422 may be input into a machine learning model usable to perform automated driving. In this example, the information may input into a layer of a neural network associated with planning. For example, the processor system 404 may determine vision information reflecting a vector space understanding of a real-world environment. In this example, the vision information may describe objects positioned about the vehicle 402, signals, and so on. The information may be used to inform driving behavior of the vehicle. The complexity information 422 may thus represent additional information which is incorporated into the vehicle's 402 understanding of the real-world environment. Thus, by understanding that a portion of an upcoming roadway has high complexity, the vehicle 402 may adjust its driving behavior (e.g., it may slow down, change lanes, and so on).

FIG. 4B is a block diagram of the complexity analysis system 100 in communication with a multitude of automated vehicles 420A-420N and intelligent transportation system (ITS) 422A-422N devices. In some embodiments, the system 100 may obtain real-time complexity information 422 (e.g., live data or other transitory, temporary, or non-permanent road-way data relevant for then-current or near-term usage) to inform its modification of complexity values as described in FIG. 1B.

The information may be obtained from vehicles 420A-420N traversing roadways. For example, the vehicles may determine traffic information, weather information, existence of construction zones (e.g., via analyzing image data), and so on. Similarly, the ITS devices may include cameras, radar detectors, loop detectors, road weather information system (RWIS) detectors, and so on. This information may thus be fed into the system 100 and used to update complexity values in substantially real-time.

The system 100 may additionally respond to requests from a fleet operator of a fleet of automated vehicles. For example, the fleet operator may use a user interface to view roadways on which the fleet is traveling on or on which the fleet is going or planned to be traveling. The system 100 may then utilize live data (e.g., current traffic, weather) to update complexity values for the roadways. The user interface may then indicate (e.g., highlight) roadways which have complexity scores greater than a threshold. The user interface may indicate roadways which are preferred for certain types of automated vehicles (e.g., vehicles which can handle particular behaviors than others).

### Example User Interface

FIG. 5 is an example user interface 500 that includes roadway complexity information for a roadway. In the illustrated example, the user interface 500 includes a map depicting the roadway 504. Colors may be assigned to roadway segments which form the roadway 504, with the colors representing complexity of behaviors assigned to the roadway segments.

The user interface 500 further includes a filter 506 to identify road segments which are extreme, high, medium-high, medium, low-medium, or low. As described above, each classification may be associated with a range of complexity values or specific complexity values. Thus, extreme may represent a range of complexity values at the upper end of complexity. Additionally, a graphical representation 506 of the complexity is included. In the example, the representation 506 is a pie chart.

The user interface 500 further includes energy consumption information 508 for the roadway 504. Additionally, a chart 510 reflecting average energy consumption per distance along the roadway is included.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A method implemented by a system comprising one or more processors, the method comprising:
obtaining information defining a roadway on which an automated vehicle is to navigate, the information reflecting characteristics of portions of the roadway including real-time, geographical and/or behavior information;
determining primary behaviors associated with roadway segments which form the roadway, wherein the roadway is segmented into the roadway segments based on adjustments of primary behavior which the automated vehicle will perform;
determining complexity values for each roadway segment, wherein individual complexity values are based on the associated primary behavior and one or more complexity modifiers, and wherein a complexity modifier reflects real-time weather or traffic conditions associated with a roadway segment; and
causing presentation of a user interface, wherein the user interface includes:
a roadway complexity value determined based on the complexity values.

2. The method of claim 1, wherein the roadway reflects a roadway under development and wherein the primary behaviors are specified via user input or determined based on an analysis of an underlying model of the roadway under development.

3. The method of claim 1, wherein a primary behavior includes an intersection, a merge, or straight travel.

4. The method of claim 1, wherein a complexity modifier for a roadway segment includes speed associated with the roadway segment or density of vehicles on the roadway segment.

5. The method of claim 1, wherein determining the roadway complexity value comprises:
identifying weighting factors associated with the complexity values, wherein each weighting factor is associated with a particular range of complexity values;
aggregating, for each weighting factor, lengths of roadway segments associated with the weighting factor; and
determining determinants for each weighting factor based on the aggregated lengths, wherein the roadway complexity value is determined based on the determinants and a non-linear function.

6. The method of claim 1, wherein the user interface further includes a graphical depiction of the roadway, wherein individual roadway segments are assigned colors selected based on individual complexity values.

7. The method of claim 1, wherein the information is received from an automated vehicle traversing the roadway, and wherein the method further comprises:
providing the complexity values to the automated vehicle, wherein the automated vehicle is configured to adjust a route based on the complexity values.

8. A system comprising:
a geographic information system (GIS) database storing data associated with geographic regions, the data reflecting characteristics of portions of roadways in the geographic regions and being stored as a spatial database; and
one or more processors and non-transitory computer storage media storing instructions that when executed by the one or more processors, cause the processors to perform operations comprising:
obtaining, via the GIS database, information defining a roadway on which an automated vehicle is to navigate;
determining primary behaviors associated with roadway segments which form the roadway, wherein the roadway is segmented into the roadway segments based on adjustments of primary behavior which the automated vehicle will perform, and wherein a complexity modifier reflects real-time roadway associated with a roadway segment;
determining complexity values for each roadway segment, wherein individual complexity values are based on the associated primary behavior and one or more complexity modifiers; and
causing presentation of a user interface, wherein the user interface includes:
a roadway complexity value determined based on the complexity values.

9. The system of claim 8, wherein the roadway reflects a roadway under development and wherein the primary behaviors are specified via user input or determined based on an analysis of an underlying model of the roadway under development.

10. The system of claim 8, wherein a primary behavior includes an intersection, a merge, or straight travel.

11. The system of claim 8, wherein a complexity modifier for a roadway segment includes speed associated with the roadway segment or density of vehicles on the roadway segment.

12. The system of claim 8, wherein determining the roadway complexity value comprises:
identifying weighting factors associated with the complexity values, wherein each weighting factor is associated with a particular range of complexity values;
aggregating, for each weighting factor, lengths of roadway segments associated with the weighting factor; and
determining determinants for each weighting factor based on the aggregated lengths, wherein the roadway complexity value is determined based on the determinants and a non-linear function.

13. The system of claim 8, wherein the user interface further includes a graphical depiction of the roadway, wherein individual roadway segments are assigned colors selected based on individual complexity values.

14. The system of claim 8, wherein the information is received from an automated vehicle traversing the roadway, and wherein the method further comprises:
providing the complexity values to the automated vehicle, wherein the automated vehicle is configured to adjust a route based on the complexity values.

15. Non-transitory computer storage media storing instructions that when executed by a system of one or more processors, cause the one or more processors to perform operations comprising:
obtaining information defining a roadway on which an automated vehicle is to navigate, the information reflecting characteristics of portions of the roadway including geographical and/or behavior information;
determining primary behaviors associated with roadway segments which form the roadway, wherein the roadway is segmented into the roadway segments based on adjustments of primary behavior which the automated vehicle will perform, and wherein a complexity modifier reflects real-time weather or traffic conditions associated with a roadway segment;
determining complexity values for each roadway segment, wherein individual complexity values are based on the associated primary behavior and one or more complexity modifiers; and
causing presentation of a user interface, wherein the user interface includes:
a roadway complexity value determined based on the complexity values.

16. The computer storage media of claim 15, wherein the roadway reflects a roadway under development and wherein the primary behaviors are specified via user input or determined based on an analysis of an underlying model of the roadway under development.

17. The computer storage media of claim 15, wherein a primary behavior includes an intersection, a merge, or straight travel.

18. The computer storage media of claim 15, wherein a complexity modifier for a roadway segment includes speed associated with the roadway segment or density of vehicles on the roadway segment.

19. The computer storage media of claim 15, wherein determining the roadway complexity value comprises:
identifying weighting factors associated with the complexity values, wherein each weighting factor is associated with a particular range of complexity values;
aggregating, for each weighting factor, lengths of roadway segments associated with the weighting factor; and
determining determinants for each weighting factor based on the aggregated lengths, wherein the roadway complexity value is determined based on the determinants and a non-linear function.

20. The computer storage media of claim 15, wherein the user interface further includes a graphical depiction of the roadway, wherein individual roadway segments are assigned colors selected based on individual complexity values.
